(19) United States
(12) Patent Application Publication
(10) Pub. No.: US 2019/0381540 A1
(43) Pub. Date: Dec. 19, 2019

(54) CASE WASHERS HAVING SIDEHILL SCREEN ASSEMBLIES

(71) Applicant: Cannon Equipment LLC, Cannon Falls, MN (US)

(72) Inventor: Douglas Levine, Inver Grove Heights, MN (US)

(73) Assignee: Cannon Equipment LLC, Cannon Falls, MN (US)

(21) Appl. No.: 16/292,631

(22) Filed: Mar. 5, 2019

Related U.S. Application Data
(60) Provisional application No. 62/684,962, filed on Jun. 14, 2018.

(51) Int. Cl. B08B 9/30; B08B 3/02; B08B 3/04; B08B 3/14; B08B 9/08; B08B 9/093; B08B 13/00; B01D 29/01; B01D 29/90

(52) U.S. Cl. CPC B08B 9/30; B08B 3/022; B08B 3/041; B08B 3/14; B08B 9/0821; B08B 2209/08; B08B 9/093; B08B 13/00; B01D 29/014; B01D 29/904; B08B 9/0861

(57) ABSTRACT

A case washer for use in a dairy processing machine has an enclosure through which the cases are conveyed, a plurality of nozzles that spray a fluid into the enclosure to thereby remove debris from the cases as the cases are conveyed through the enclosure, and a funnel that receives the fluid and the debris from the enclosure. A sidehill screen assembly receives the fluid and the debris from the funnel. The sidehill screen assembly has a screen along which the fluid and the debris are conveyed such that the fluid percolates through the screen and the debris is collected on the screen and the debris falls off the screen under force of gravity.

### CROSS-REFERENCE TO RELATED APPLICATION

The present disclosure is based on and claims priority to U.S. Provisional Patent Application No. 62/684,962 filed Jun. 14, 2018, the disclosure of which is incorporated herein by reference.

### FIELD

The present disclosure relates to dairy processing machines that receive, process, and fill cases, and specifically to case washers for use with dairy processing machines to wash cases.

### BRIEF DESCRIPTION OF THE DRAWINGS

The present disclosure is described with reference to the following Figures. The same numbers are used throughout the Figures to reference like features and like components.

FIG. 1 is a perspective view of an example case washer of the present disclosure.

FIG. 2 is a first perspective view of the case washer of FIG. 1.

FIG. 3 is a second perspective view of the case washer of FIG. 1

FIG. 4 is a partial cross-sectional view of the case washer of FIG. 1 along line 4-4 on FIG. 1.

FIG. 5 is a cross-sectional view of the case washer of FIG. 1 along line 5 on FIG. 1.

FIG. 6 is another cross-sectional view of the case washer of FIG. 1.

FIG. 7 is a front elevation view of a sidehill screen assembly.

FIG. 8 is another example case washer of the present disclosure.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a case washer for use in a dairy processing machine has an enclosure through which the cases are conveyed, a plurality of nozzles that spray a fluid into the enclosure to thereby remove debris from the cases as the cases are conveyed through the enclosure, and a funnel that receives the fluid and the debris from the enclosure. A sidehill screen assembly receives the fluid and the debris from the funnel. The sidehill screen assembly has a screen along which the fluid and the debris are conveyed such that the fluid percolates through the screen and the debris is collected on the screen and the debris falls off the screen under force of gravity.

Various other features, objects, and advantages will be made apparent from the following description taken together with the drawings.

### DETAILED DESCRIPTION

Reusable dairy cases are typically used to transport dairy products, such as pint milk cartons, half gallon milk cartons, and gallon milk jugs, to retail locations. These reusable dairy cases are filled with the dairy products at a bottling factory, shipped to retail locations, and then returned empty to the bottling factory for reuse. Often, the reusable dairy cases are returned dirty or with trash, such as packaging plastic. Accordingly, the bottling factory uses a dairy processing machine with a case washer to wash and clean returned dairy cases prior to refilling the dairy cases with salable dairy products.

To properly clean returned diary cases, the dairy cases are conveyed on tracks through the case washer where high-pressure nozzles spray fluid (e.g., water, cleaning fluid) onto the dairy case to thereby wash and remove debris. The nozzles are positioned in a tunnel, and the tracks on which the dairy cases are conveyed extend through the tunnel. The fluid, dirt, and debris fall into a collection tank positioned vertically below the tunnels and the tracks. Filter units filter the fluid in the collection tank, and a pump pumps the fluid in the collection tank back to the nozzles. The present inventor has observed that the nozzles and filter units of conventional case washers often quickly become clogged with dirt and debris. In addition, large pieces of debris often accumulate on the surface of the water in the collection tank.

To ensure efficient and effective operation of the case washer, the filter units must be periodically cleaned and/or replaced and the accumulation of large pieces of debris in the collection tank must be removed. In order to clean the filter units and/or remove the large pieces of debris from the collection tank, the case washer and the entire dairy processing machine must be shut down and taken out of service. As a result, the productivity of the dairy processing machine is reduced. The amount of time and the frequency at which the case washer and dairy processing machine must be taken out of service often depends on the amount of the dirt and debris that is removed from the dairy cases.

The present inventor has recognized that it is desirable to reduce the amount of time the case washer and the dairy processing machine must be taken out of service for cleaning and maintenance. Furthermore, it is desirable to reduce the frequency at which case washer must be cleaned. Accordingly, through research and experimentation, the present inventor has developed the case washer of the present disclosure that advantageously reduces the amount of time and the frequency at which the case washer and the dairy processing machine must be taken out of service. In addition, the case washer of the present disclosure advantageously requires little cleaning or maintenance and permits days or weeks to pass without shutting down the case washer and the dairy processing machine for cleaning and maintenance.

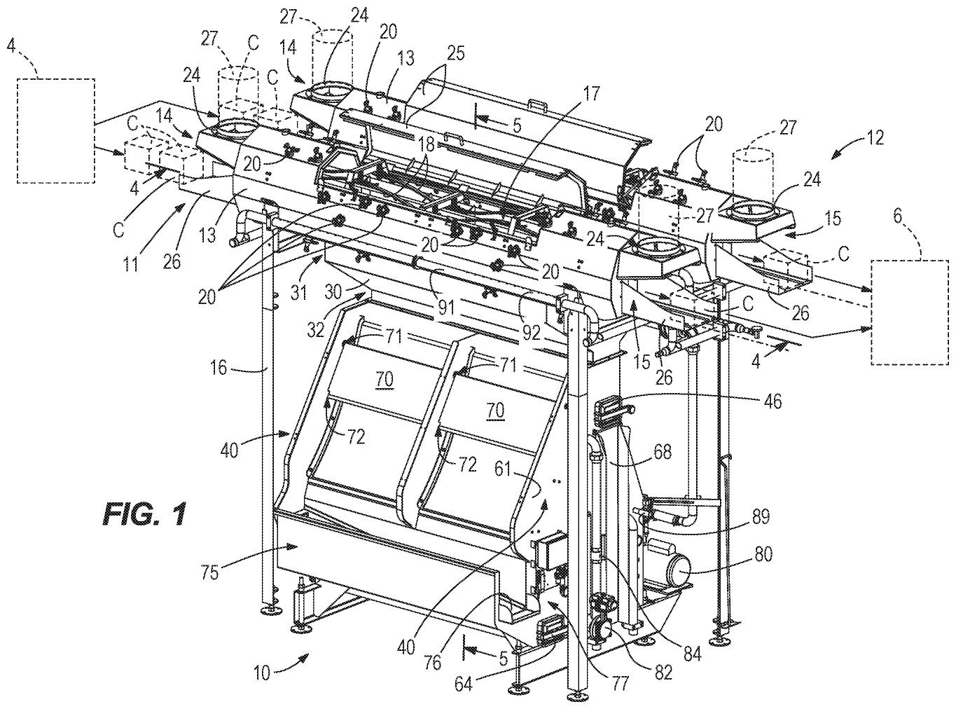

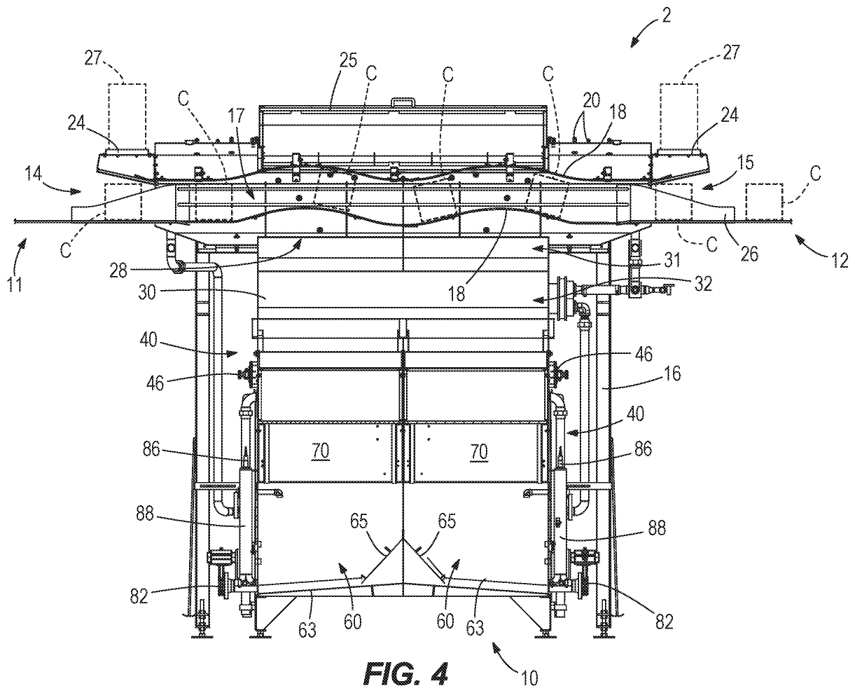

FIGS. 1-4 depict an example case washer 10 of the present disclosure for washing cases C conveyed therethrough. The case washer 10 is a part of a dairy processing machine 2 that includes upstream and downstream stations 4, 6 that further process, fill, and/or convey the cases C. For example, the upstream station(s) 4 can be configured to receive, organize, and/or convey the cases C to the case washer 10. The downstream stations 6 are configured to receive the washed cases C from the case washer 10 and fill the cases C with salable dairy containers.

Specifically, the case washer 10 is configured to wash the cases C before the cases C are filled with dairy containers at a downstream station 6. The case washer 10 includes an upstream end 11 that receives the cases C from the upstream station 4 and an opposite downstream end 12 that dispenses washed cases C to the downstream station 6. Generally, the case washer 10 has one or more enclosures 13 through which the cases C are conveyed and sprayed with a fluid to thereby wash the cases C. The fluid and any debris is then conveyed by gravity vertically downwardly into one or more sidehill screen assemblies 40 that filter the debris from the fluid and recirculate the fluid back to the enclosures 13 to wash additional cases C (described herein below).

In particular, the cases C are conveyed through a pair of parallel enclosures 13 that each has an inlet 14 for receiving dirty cases C and an outlet 15 through which washed cases C are dispensed. The enclosures 13 are supported on a rigid frame 16. Each enclosure 13 defines a tunnel 17 that extends between the inlet 14 and the outlet 15. Tracks 18 extend through the tunnel 17 and guide the cases C therethrough. In certain examples, the tracks 18 extend along a serpentine path such that the cases C are rotated and/or inverted as they are conveyed through the tunnel 17 such that all surfaces of the cases C are washed and/or debris in the cases C is dumped out. The cases C are conveyed through the case washer 10 by a conveyor (not shown) and/or pushed through the case washer 10 by upstream cases C. The number of enclosures 13 can vary, and in another example, the case washer 10 includes one enclosure 13.

As the cases C are conveyed through the enclosures 13, the cases C are washed by fluid sprayed into the enclosure via nozzles 20. The nozzles 20 are coupled to the enclosures 13, and the fluid may be a cleaning fluid or water. The nozzles 20 receive the fluid from a pump 80 (described herein) via fluid lines. The nozzles 20 extend into the enclosures 13, and clamps, such as tri-clover clamps, clamp the nozzles 20 onto the exterior surface of the enclosures 13. The clamps permit the nozzles 20 to be easily disconnected from the enclosures 13 for cleaning and/or maintenance. Furthermore, coupling the nozzles 20 to the outside of the enclosure s13 reduces the number of surfaces in the tunnel 17 to which dirt, grime, and/or debris can adhere. In the event the operator requires access to the tunnels 17, a maintenance door 25 is pivotable into an open position (note FIGS. 1-4 depict the maintenance doors 25 in the open position). In certain examples, exhaust fans 24 are positioned at the inlets 14 and the outlets 15 of the enclosures 13 to exhaust air and/or steam that escape out of the enclosures 13. The exhaust fans 24 are connected to a building ventilation system 27 (FIG. 1). In certain examples, drip trays 26 are also positioned at the inlets 14 and/or the outlets 15 to thereby direct any residual fluid that drips off of the cases C back into the tunnels 17. The drip trays 26 are sloped inwardly toward the tunnels 17.

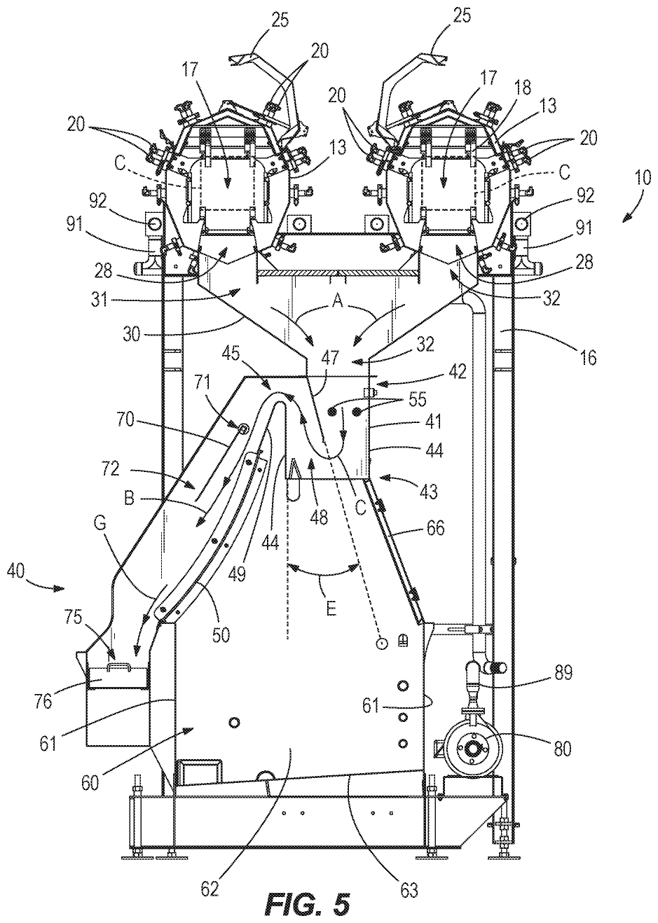

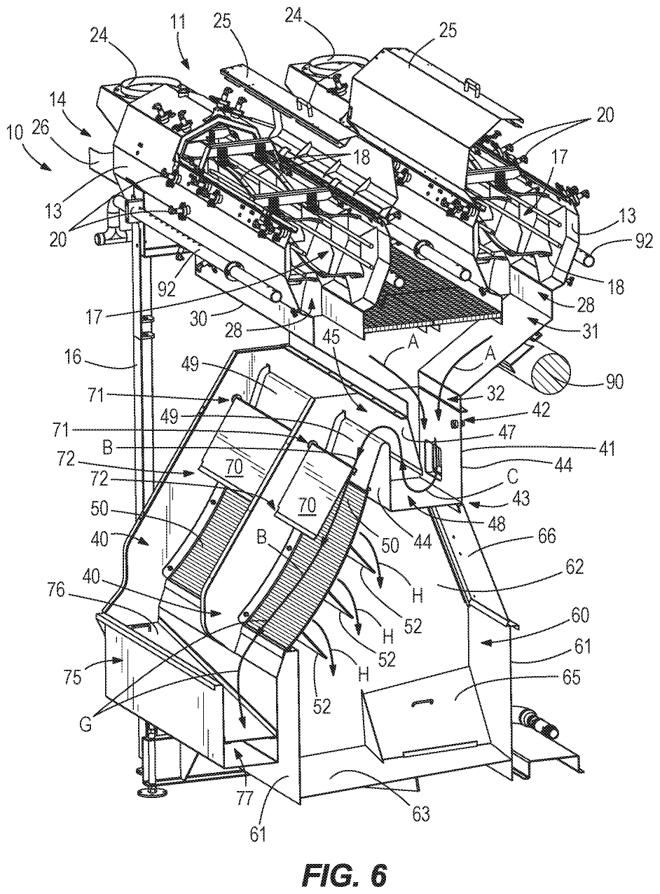

Referring to FIGS. 5-6, each enclosure 13 also has a bottom opening 28 through which the fluid sprayed into the tunnels 17 and the debris removed from the cases C exit the enclosures 13. The fluid and the debris are then conveyed by gravity into one or more funnels 30 that are vertically below the enclosures 13. In particular, each funnel 30 includes an inlet end 31 that receives the fluid and the debris from the enclosures 13 and an outlet end 32 that dispenses the fluid and the debris to one or more sidehill screen assemblies 40 which filter the debris from the fluid (described herein). The inlet end 31 of the funnel 30 has a cross-sectional area that is greater than the cross-sectional area of the outlet end 32 such that the fluid and the debris are funneled toward the sidehill screen assembly 40. In the example depicted, the case washer 10 has one funnel 30 that directs the fluid and the debris to two sidehill screen assemblies 40. In other examples, separate funnels 30 direct the fluid and the debris to separate sidehill screen assemblies 40. The number of sidehill screen assemblies 40 can vary. A funnel hatch (not shown) allows an operator to access the interior of the funnel 30 to thereby clean the funnels 30 and/or remove large pieces of debris that may become stuck in the funnel 30.

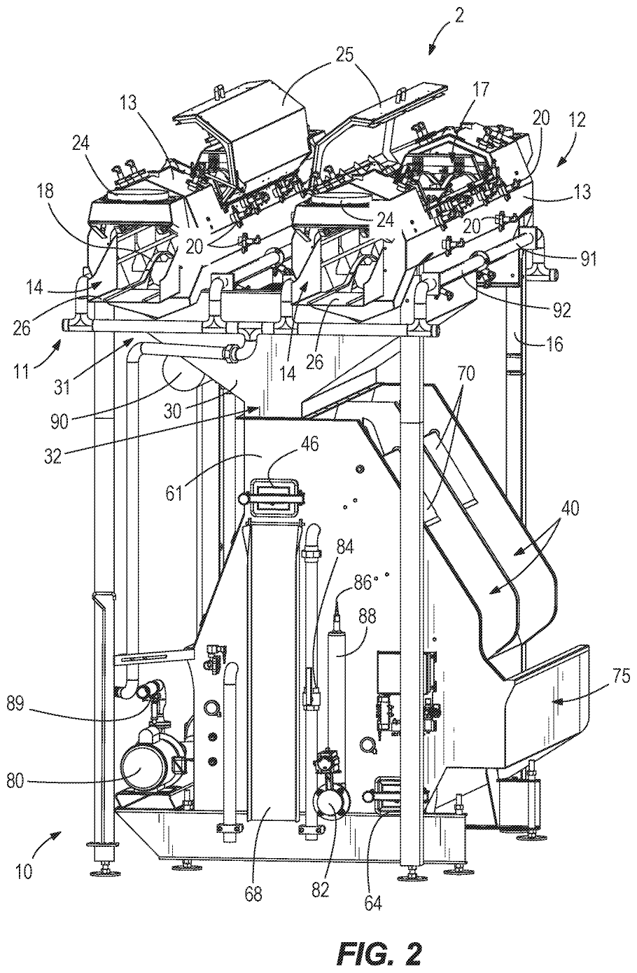

The fluid and the debris passing through the funnel 30 are dispensed into the sidehill screen assembly 40 where the debris is filtered out of the fluid (described further herein). In particular, the outlet end 32 of the funnel is connected to an open end 42 of a receiving tank 41 that receives the fluid and the debris (see arrows A on FIG. 6) and dispenses the fluid and the debris to a screen 50 (see arrow B on FIG. 6). The extents of the receiving tank 41 are defined by a closed end 43, which is vertically below the open end 42, and one or more tank sidewalls 44. An aperture 45 is defined in one of the tank sidewalls 44, and the fluid and the debris are conveyed through the aperture 45 to the screen 50 (see arrow B on FIG. 6). The aperture 45 is vertically between the open end 42 and the closed end 43 such that the fluid and the debris collect or pool in the receiving tank 41 until the level of the fluid and the debris in the receiving tank 41 reaches the aperture 45. Once the level of the fluid and the debris in the receiving tank 41 reaches the aperture 45, the fluid and the debris flow by gravity along the screen 50 (see arrow B on FIG. 6). Preferably, the level of the fluid and the debris is one inch above (e.g. 1.0 inch head) the bottom of the aperture 45. A hatch 46 (FIG. 2) allows an operator to access the interior of the receiving tank 41 for cleaning and/or maintenance. In certain examples, downwardly sloping bars 55 (FIG. 5) are positioned in the receiving tank 41 to prevent large pieces of debris, such as pieces of corrugated cardboard, from flowing through the receiving tank 41 and through the aperture 45. The sloped bars 55 are sloped toward the hatch 46 such that the large pieces of debris are guided toward the hatch 46 for removal.

The sidehill screen assembly 40 includes a baffle 47 that extends into the receiving tank 41 and around which the fluid and the debris flow (see arrow C on FIG. 6) as the fluid and the debris is conveyed through the receiving tank 41. The baffle 47 extends from the open end 42 toward the closed end 43 such that a passage 48 is defined between the baffle 47 and the closed end 43 and through which the fluid and the debris flow. The baffle 47 is configured to agitate the debris in the fluid and/or smooth the flow of the fluid and the debris dispensed via the aperture 45. In certain examples, the baffle 47 is angled away from the tank sidewall 44 in which the aperture 45 is formed. In this example, the tank sidewall 44 in which the aperture 45 is formed and the baffle 47 form an acute angle E (FIG. 5).

The fluid and the debris dispensed via the aperture 45 are conveyed by gravity along an outer sidewall 49 to the screen 50. The outer sidewall 49 is coupled to the tank sidewall 44 in which the aperture 45 is formed such that the fluid and the debris smoothly flow through the aperture 45 onto the outer sidewall 49. The fluid and the debris are then conveyed by gravity onto the screen 50. The outer sidewall 49 is outwardly sloped away from the receiving tank 41. In certain examples, the slope and/or shape of the outer sidewall 49 matches or closely corresponds to the slope and/or shape of the screen 50.

As the fluid and the debris flow along the screen 50 (see arrow B of FIG. 6), the fluid percolates through the screen 50 (see arrows H on FIG. 6) into a collection tank 60 such that the debris is collected on the screen 50 (e.g. the screen 50 filters the debris out of the fluid such that debris remains on top of the screen 50). As will be discussed in greater detail below, the debris falls off the screen 50 under the force of gravity (see arrows G on FIG. 6) as the debris accumulates on the screen 50. The screen 50 is outwardly sloped away from the receiving tank 41. In certain examples, the screen 50 is parallel with the outer sidewall 49. In certain examples, the screen 50 is a parabolic screen. The screen 50 has a plurality of openings (e.g. holes, slits) through which the fluid percolates. The size and shape of the openings can vary, and in one example the openings are 0.02 inch diameter holes. The screen 50 is supported by one or more support members 52 that are in the collection tank 60 and extend across the screen 50. The support members 52 are also configured to direct the fluid (see arrows H on FIG. 6) percolating through the screen 50 inwardly away from the screen 50 and into the collection tank 60.

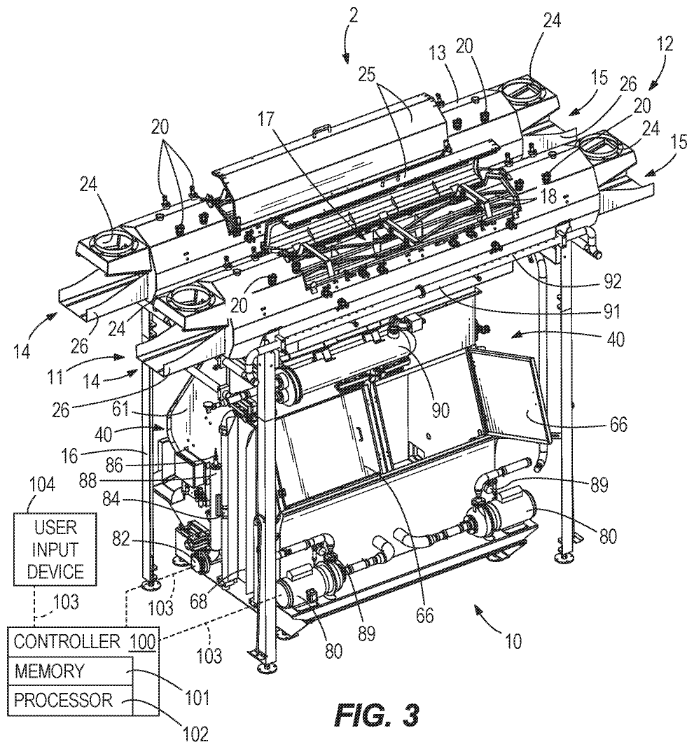

The collection tank 60 is a generally closed tank with a plurality of sidewalls 61. In certain examples, a dividing wall 62 separates adjacent collection tanks 60. One or more access doors 66 are operably coupled to the collection tank 60 such that the operator can access the interior of the collection tank 60 for cleaning and maintenance. FIG. 3 depicts one access door 66 for each collection tank 60. Note that one of the access doors 66 is in the closed position and one access door 66 is in the open position.

The collection tank 60 has a bottom surface 63 that is sloped toward a hatch 64 such any debris in the collection tank 60 is directed toward the hatch 64. The operator opens the hatch 64 to clean the collection tank 60 and/or pull the debris out of the collection tank 60. In another example, the debris in the collection tank 60 flows by gravity out of the hatch 64. A pump screen 65 is positioned in the collection tank 60 to prevent large debris from clogging a pump 80 that circulates the fluid in the collection tank 60 to the nozzles 20. In this way, the fluid in the collection tank 60 can be recycled and recirculated to clean additional cases C.

The fluid in the collection tank 60 may also be periodically discarded or removed from the collection tank 60 based on scheduled maintenance procedures. In one example, the operator may simply open a drainage valve 82 on the collection tank 60 such that the fluid in the collection tank 60 drains out of the collection tank 60. However, in another example the drainage valve 82 may be controlled by a programmable logic controller (PLC) 100 (see FIG. 2) based on preprogrammed maintenance schedules. Accordingly, the case washer 10 is further automated and requires less manual maintenance. The PLC includes a memory 101 and a processor 102 and is connected to the drainage valve 82 with a wired or wireless communication link 103 (see FIG. 2).

A maintenance program or schedule is stored on the memory 101. In certain examples, the drainage valve 82 can be opened based on the amount of the fluid circulated by the pump 80 (e.g. after the pump 80 pumps nine thousand gallons of the fluid the drainage valve 82 is opened) or specific timeframe (e.g. after two weeks of operation the drainage valve 82 is opened). The PLC 100 is connected to a user input device 104 (FIG. 2) into which the maintenance program may be entered. The user input device 104 may also permit the operator to open the drainage valve 82 at any time.

A fluid inlet valve 84 is also coupled to the collection tank 60 and is for filling the collection tank 60 with the fluid (e.g. water). The fluid inlet valve 84 is connected to a fluid source (e.g. pressurized water source, cleaning fluid tank), and the fluid inlet valve 84 can be manually opened by the operator to thereby add fluid to the collection tank 60. In another example, the fluid inlet valve 84 is connected to and controlled by the PLC 100. In this example, the fluid inlet valve 84 is opened and closed automatically based on a maintenance program (e.g. after the fluid is drained via the drainage valve 82 the fluid inlet valve 84 adds new fluid to the collection tank 60). Also, the PLC 100 may open the fluid inlet valve 84 when the level of the fluid in the collection tank 60 during operation falls below a predetermined operating fluid level. In certain examples, the drainage valve 82 is an air-actuated valve that is coupled via air tubes (not shown) to a pressurized air source (not shown).

The fluid level in the collection tank 60 is sensed by a sensor 86 that is connected to the sidewall 61 of the collection tank 60 and is in communication with the PLC 100. The sensor 86 is configured to sense the fluid level in the collection tank 60 and send signals (e.g. analog output signals) to the PLC 100 such that the fluid level in the collection tank 60 can be determined by the PLC 100. In the event the fluid level in the collection tank 60 is below a predetermined level (e.g. a predetermined operating fluid level), the PLC 100 opens the fluid inlet valve 84 to thereby add fluid to the collection tank 60. Once the fluid level is at the predetermined level, the fluid inlet valve 84 is closed. In another example, a water level pipe 88 is provided on the sidewall 61 of the collection tank 60 and is for displaying the fluid level in the collection tank 60. The sensor 86 senses the fluid level in the water level pipe 88. The type of sensor 86 can vary, and in some examples, the sensor 86 is an ultrasonic water level sensing device such as the device commercially available from manufacturer SICK (Model# UP56-21211B).

A pressure transducer 89 is coupled to the pump 80 and is for monitoring the pressure of the fluid conveyed to the nozzles 20. The pressure transducer 89 is in communication with the PLC 100 and provides signals to the PLC 100 that correspond to the pressure of the fluid conveyed to the nozzles 20. In operation, the size and/or number of the sidehill screen assemblies 40 is dependent on the flow rate (gallons per minute) of the fluid needed to be pumped by the pump 80 to adequately clean the cases C and the flow rate of the fluid through the screen(s) 50. For instance, the flow rate of the fluid pumped by the pump 80 should not exceed the flow rate of the fluid percolating through the screen(s) 50. In a specific example, if the screens 50 permit 100.0-150.0 gallons of the fluid per minute to percolate therethrough into the collection tank 60 the pump 80 should pump the fluid at a rate of less than or equal to 100.0-150.0 gallons per minute. In addition, the flow rate of the fluid pumped may be increased or decreased based on the fluid level in the collection tank 60 sensed by the sensor 86. For instance, if the fluid level is sensed to be decreasing the PLC 100 decreases the flow rate of the fluid pumped by the pump 80 and/or alerts the operator that the fluid is being lost in the system or the screen 50 has become clogged.

A heater 90 can be included with the sidehill screen assembly 40 to heat the fluid pumped by the pump 80. The heater 90 is positioned downstream from the pump 80 and receives the fluid. Steam from a steam source (not shown) is also received into the heater 90 such that heat transfers to the fluid. The heated fluid is further conveyed to the nozzles 20 where the fluid is sprayed onto the cases C. In another example, the heated water is conveyed to a fluid manifold 91 that receives the heated fluid and dispenses the heated water via flexible tubing (not shown) to the nozzles 20. The fluid manifold 91 includes a perforated tube 92 that distributes the heated water to each flexible tubing and the connected nozzle 20. The size and type of heater 90 can vary, and in one example the heater 90 is a tube and shell heat exchanger. The temperature of the heated water can vary based on the application of the case washer 10. In one example, the temperature of the heated fluid is 160.0 degrees Fahrenheit. In one example, the fluid manifold 91 includes two perforated tubes 92 with a total of sixty-four perforations or holes that are connected to sixty-four flexible tubes and sixty-four spray nozzles 20.

Still referring to FIGS. 5-6, the sidehill screen assembly 40 also has a pivotable barrier device 70 positioned adjacent to screen 50 to prevent the fluid and/or debris from falling off the screen 50 before the debris is properly filtered by the screen 50, as described above. In particular, the barrier device 70 is pivotably coupled to the sidehill screen assembly 40 at a first end 71 and has a free, second end 72. As such, the barrier device 70, specifically the second end 72, is biased by gravity toward the screen 50 such that the barrier device 70 contacts and compresses the debris on the screen 50 to thereby keep the debris on the screen 50 and/or compress residual amounts of the fluid in the debris out of the debris. In certain examples, the second end 72 pivots away from the screen 50 when the amount of the debris on the screen 50 increases. The barrier device 70 also compresses (by gravity) the debris onto the screen 50 as debris moves along the screen 50.

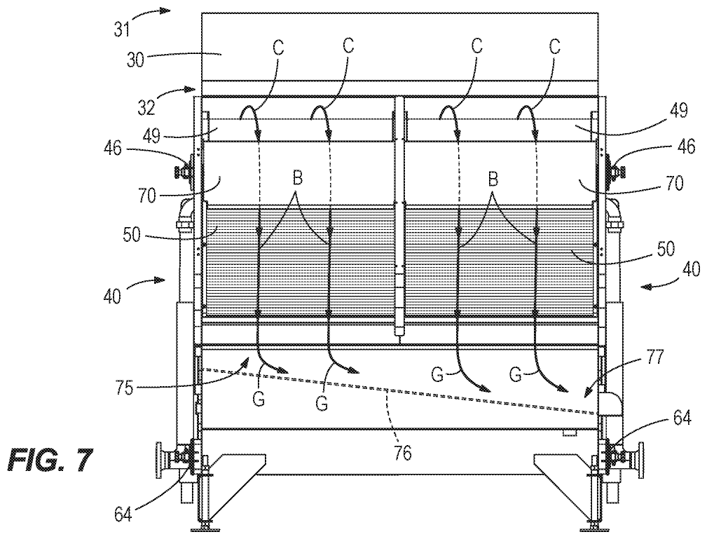

Referring to FIG. 7, the sidehill screen assembly 40 also has a trough 75 vertically below the screen 50 that catches and collects the debris that falls off the screen 50. The trough 75 has a sloped a sloped bottom surface 76 along which the debris in the trough 75 conveys by gravity to an open end 77 where the debris falls off the trough 75 into a container such as a movable bucket or garbage bin. Furthermore, the operator may push or pull the debris along the sloped bottom surface 76 and out of the trough 75 to thereby clean and maintain the sidehill screen assembly 40. In other examples, the debris is transported away from the case washer 10 by a conveyor (not shown) or deposited onto the ground for removal by maintenance crews.

Referring back to FIG. 2, a hinged trough 68 is on the sidewall 61 of the collection tank 60 vertically below the hatch 46 on the receiving tank 41. The hinged trough 68 is movable into and between a first position in which the hinged trough 68 extends along the sidewall 61 and a second position in which the hinged trough 68 extends away from the sidewall 61. In the second position, the hinged trough 68 downwardly sloped away from the sidewall 61 and the hatch 46. When the hatch 46 is open and the hinged trough 68 is in the second position, the operator can pull debris from the receiving tank 41 via the hatch 46 onto the hinged trough 68. The debris then flows by gravity along the hinged trough 68 (or by pushing on the debris along the hinged trough 68). In certain examples, a plurality of ports (not shown) are provided in the sidewalls 61 for attachment and/or insertion of sensors (e.g. temperature sensors) and/or chemical solution pipes into the collection tank 60.

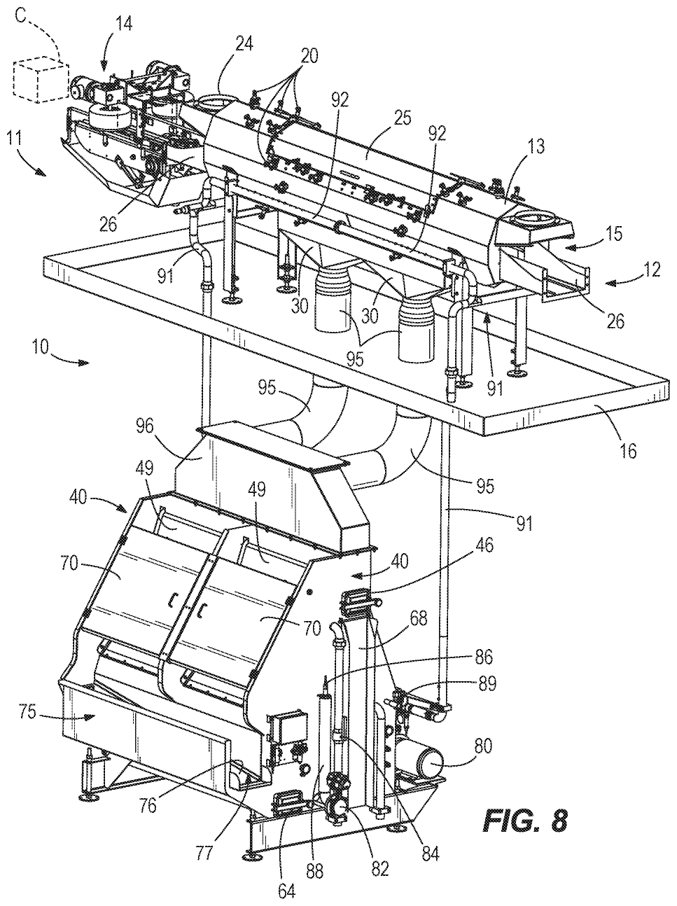

FIG. 8 depicts another example of a case washer 10 with a pair of sidehill screen assemblies 40. In this example, the funnels 30 are not directly connected to the sidehill screen assemblies 40. Instead, piping 95 and a collection structure 96 direct the fluid and the debris to the sidehill screen assemblies 40. The size, shape, orientation, and type of the piping 95 and the collection structure 96 can vary and may be based on the application of the case washer 10. For example, the case washer 10 shown in FIG. 8 may be advantageously used in factories in which the enclosure(s) 13 through which the cases C are conveyed is at an increased vertical elevation above the ground. Accordingly, the piping 95 and the collection structure 96 route the fluid and the debris to the sidehill screen assemblies 40 on the ground. A person having ordinary skill in the art will recognize that the case washer 10 depicted in FIG. 8 can include or exclude any of the components described hereinabove with respect to the case washer 10 shown in FIGS. 1-7.

A person of ordinary skill in the art will also recognize the number of components of the case washer 10 may be increased or decreased depending on the application of the case washer 10. For instance, the examples depicted in FIGS. 1-7 and FIG. 8 include two sidehill screen assemblies 40. In other examples, a single sidehill screen assembly 40 is used. In another example, four sidehill screen assemblies 40 are placed in a line relative to each other. In another example, the sidehill screens assemblies 40 are placed back to back such that debris falls off the screens 50 of each sidehill screens assembly 40 in different directions.

In addition, the present inventor has contemplated that the case washer 10 can be divided into a first section in which the nozzles 20 spray a cleaning fluid onto the cases C and an adjacent second section in which the nozzles 20 sprays a rinsing fluid (e.g. water) onto the cases C. In this example, the cleaning fluid and the debris in the first section are processed by a first sidehill screen unit and the rinsing fluid and any additional debris in the second section are processed by a separate second sidehill screen unit.

In the present description, certain terms have been used for brevity, clarity, and understanding. No unnecessary limitations are to be inferred therefrom beyond the requirement of the prior art because such terms are used for descriptive purposes only and are intended to be broadly construed. The different apparatuses, systems, and methods described herein may be used alone or in combination with other apparatuses, systems, and methods. Various equivalents, alternatives, and modifications are possible within the scope of the appended claims.

What is claimed is:

1. A case washer for use in a dairy processing machine and for washing cases, the case washer comprising:
an enclosure through which the cases are conveyed;
a plurality of nozzles that spray a fluid into the enclosure to thereby remove debris from the cases as the cases are conveyed through the enclosure;
a funnel that receives the fluid and the debris from the enclosure; and
a sidehill screen assembly that receives the fluid and the debris from the funnel, wherein the sidehill screen assembly has a screen along which the fluid and the debris are conveyed such that the fluid percolates through the screen and the debris is collected on the screen, and wherein the debris falls off the screen under force of gravity.

2. The case washer according to claim 1, wherein the sidehill screen assembly has a receiving tank in which the fluid and the debris from the funnel are received before the fluid and the debris are conveyed along the screen.

3. The case washer according to claim 2, wherein the receiving tank has an upper end coupled to the funnel and a tank sidewall with an aperture through which the fluid and the debris flow through onto the screen, and wherein the aperture is vertically below the upper end to thereby prevent the fluid and the debris in the receiving tank from backing up into the funnel.

4. The case washer according to claim 2, wherein the sidehill screen assembly has a baffle that extends into the receiving tank and around which the fluid and the debris flow.

5. The case washer according to claim 4, wherein the receiving tank has a lower end opposite the upper end, and wherein the baffle extends from the upper end toward the lower end such that the fluid and the debris are conveyed around the baffle before being conveyed along the screen.

6. The case washer according to claim 5, wherein a passage is defined between the baffle and the lower end through which the fluid and the debris are conveyed.

7. The case washer according to claim 5, wherein the baffle is angled away from the tank sidewall.

8. The case washer according to claim 1, further comprising a barrier device positioned along the screen to compress the debris onto the screen and thereby remove residual amounts of the fluid from the debris.

9. The case washer according to claim 2, wherein the barrier device is pivotably coupled to the sidehill screen assembly, and wherein the barrier device is biased toward the screen by gravity such that the debris on the screen is compressed onto the screen.

10. The case washer according to claim 1, further comprising a trough into which the debris falls off the screen.

11. The case washer according to claim 10, wherein the trough has a sloped lower surface along which the debris is conveyed along by gravity to an open end.

12. The case washer according to claim 1, further comprising a collection tank into which the fluid percolating through the screen is received.

13. The case washer according to claim 12, wherein the collection tank is vertically directly below a receiving tank in which the fluid and the debris are received from the funnel before the fluid and the debris are conveyed along the screen.

15. The case washer according to claim 12, further comprising a pump that recirculates the fluid in the collection tank to a plurality of nozzles.

16. The case washer according to claim 2, wherein the sidehill screen assembly has a sidewall along which the fluid and the debris flow are conveyed to the screen, and wherein the sidewall and the screen are outwardly sloped away from the receiving tank.

17. The case washer according to claim 2, wherein the screen is outwardly sloped away from the receiving tank.

18. The case washer according to claim 17, wherein the screen is a sloped parabolic screen.

19. The case washer according to claim 17, wherein the screen has a plurality of openings through which the fluid percolates.

20. The case washer according to claim 17, wherein the sidehill screen assembly has a support member extending along the screen to thereby support the screen and inwardly direct the fluid percolating through the screen toward the receiving tank.
